(19) United States
(12) Patent Application Publication
(10) Pub. No.: US 2024/0233147 A1
(43) Pub. Date: Jul. 11, 2024

(54) IMAGE PROCESSING APPARATUS, IMAGE PROCESSING METHOD, AND STORAGE MEDIUM

(71) Applicant: OLYMPUS MEDICAL SYSTEMS CORP., Tokyo (JP)

(72) Inventor: Kazuaki WAKANA, Tokyo (JP)

(73) Assignee: OLYMPUS MEDICAL SYSTEMS CORP., Tokyo (JP)

(21) Appl. No.: 18/095,783

(22) Filed: Jan. 11, 2023

(51) Int. Cl. G06T 7/33; G06T 7/00; G06T 7/246

(52) U.S. Cl. CPC G06T 7/337; G06T 7/0012; G06T 7/246; G06T 2207/10016; G06T 2207/10064; G06T 2207/10068; G06T 2207/30104

(57) ABSTRACT

An image processing apparatus includes a processor. The processor is configured to: set a plurality of tracking points uniformly arranged in a first image that is one of the time series of images; track each of the tracking points from the first image to a second image and determine the success or failure in tracking each of the tracking points, the second image being an image at a different time from the first image among the time series of images; estimate an image plane of the second image by perspective projection transformation using the tracking points tracked successfully; correct the positions of the tracking points failed to be tracked on the second image by back projection to the image plane; and perform image registration on the second image based on the plurality of tracking points to generate a registration image.

### TECHNICAL FIELD

The present invention relates to an image processing apparatus, an image processing method, and a storage medium.

### BACKGROUND ART

Conventionally, blood flow assessment using a fluorescent contrast medium such as indocyanine green (ICG) has been widely known and performed (e.g., see PTL 1). In an organ, the fluorescence intensity from the fluorescent contrast medium is gradually increased by blood flow. The blood flow is assessed based on a time Tmax from the rising edge to the maximum of the fluorescence intensity.

On the other hand, a technique for tracking a non-rigid object in an image is known (e.g., see PTL 2). PTL 2 describes a system and method for modeling a non-rigid-body motion of an object using thin plate spline (TPS) transformation.

### CITATION LIST

### Patent Literature

{PTL 1}
U.S. Pat. No. 10,219,742
{PTL 2}
Japanese Translation of PCT International Application, Publication No. 2008-544404

### SUMMARY OF INVENTION

### Technical Problem

In the blood flow assessment, the fluorescence intensity at the same position of an organ is measured over a certain period of time (e.g., one to two minutes). However, organs of a living body are deformed by pulsation or the like. Further, in a case where an organ is observed with a hand-held endoscope, the field of view of the endoscope moves due to variations in the distance and angle between the endoscope and the organ. It is thus difficult to continue measuring the fluorescence intensity at the same position.

One technique for performing measurement at the same position of a subject is a method of tracking a region of interest (ROI) set in an image. In this method, a region where the ROI can be set is limited to regions having features in a treatment instrument, an organ, and the like, and it is difficult to track an arbitrary position. Further, the longer the tracking time, the more likely it is that the tracking will fail, thus making it difficult to keep track of the ROI for a long period of time, such as one to two minutes.

Another technique for tracking a subject is a method of deforming an image as described in PTL 2. In this method, a plurality of control points set in an image are tracked, and the image is deformed based on the control points. However, as in the case of the ROI, it is difficult to keep track of the control points for a long period of time.

### Solution to Problem

One aspect of the present invention is an image processing apparatus for processing a time series of images of a subject, the image processing apparatus including a processor. The processor is configured to: set a plurality of tracking points uniformly arranged in a first image that is one of the time series of images, track each of the tracking points from the first image to a second image and determine the success or failure in tracking each of the tracking points, the second image being an image at a different time from the first image among the time series of images, estimate an image plane of the second image by perspective projection transformation using the tracking points tracked successfully, correct the positions of the tracking points failed to be tracked on the second image by back projection to the image plane, and perform image registration for aligning the second image with the first image on the second image based on the plurality of tracking points to generate a registration image.

Another aspect of the present invention is an image processing method for processing a time series of images of a subject, the image processing method comprising: setting a plurality of tracking points uniformly arranged in a first image that is one of the time series of images; tracking each of the tracking points from the first image to a second image and determining success or failure in tracking each of the tracking points, the second image being an image at a different time from the first image among the time series of images; estimating an image plane of the second image by perspective projection transformation using the tracking points tracked successfully; correcting the positions of the tracking point failed to be tracked on the second image by back projection to the image plane; and performing image registration for aligning the second image with the first image on the second image based on the plurality of tracking points to generate a registration image.

Another aspect of the present invention is a non-transitory computer-readable storage medium storing an image processing program for processing a time series of images of a subject. The image processing program causes a computer to execute: setting a plurality of tracking points uniformly arranged in a first image that is one of the time series of images; tracking each of the tracking points from the first image to a second image and determining success or failure in tracking each of the tracking points, the second image being an image at a different time from the first image among the time series of images; estimating an image plane of the second image by perspective projection transformation using the tracking points tracked successfully; correcting positions of the tracking points failed to be tracked on the second image by back projection to the image plane; and performing image registration for aligning the second image with the first image on the second image based on the plurality of tracking points to generate a registration image.

### BRIEF DESCRIPTION OF DRAWINGS

FIG. 1 is an overall configuration diagram of a system according to an embodiment of the present invention.

FIG. 2 is a block diagram of an image processing apparatus according to an embodiment of the present invention.

FIG. 3 is a flowchart of an image processing method executed by the image processing apparatus.

FIG. 4A is a flowchart of step S1 of setting tracking points.

FIG. 4B is a flowchart of step S2 of tracking the tracking points.

FIG. 4C is a flowchart of step S9 of analyzing a time series of registration images.

FIG. 5A is a view illustrating a target image with a plurality of tracking points set.

FIG. 5B is a view illustrating a source image after time has elapsed from the target image.

FIG. 5C is a view illustrating a registration image of a fluorescent image paired with the source image of FIG. 5B.

FIG. 6A is a view illustrating tracking points on the source image.

FIG. 6B is a view illustrating tracking points on the source image after positions of tracking points, which were failed to be tracked, have been corrected.

FIG. 7 is a diagram for explaining perspective projection transformation.

FIG. 8 is a diagram illustrating an example of data of a temporal change in fluorescence intensity obtained from a time series of registration images.

FIG. 9 is a table illustrating an example of the relationship between a subject/surgical procedure and tracking conditions.

### DESCRIPTION OF EMBODIMENT

An image processing apparatus, an image processing method, and a storage medium according to an embodiment of the present invention will be described below with reference to the drawings.

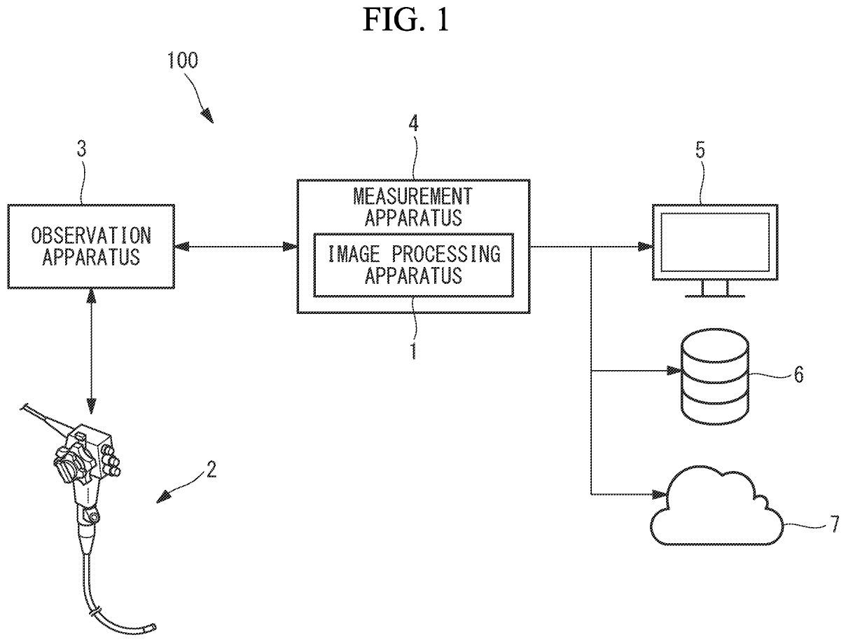

FIG. 1 illustrates an example of a system 100 to which an image processing apparatus 1 according to the present embodiment is applied. The system 100 is an endoscope system including an endoscope 2, an observation apparatus 3, a measurement apparatus 4, and a display apparatus 5, and the image processing apparatus 1 is mounted on the measurement apparatus 4. The observation apparatus 3 and the measurement apparatus 4 mutually transmit and receive signals such as video signals and control signals. The measurement apparatus 4 may be connected to servers such as a physical server 6 and a cloud server 7, and the analysis results generated by the measurement apparatus 4 and the image processing apparatus 1 may be stored in the servers 6, 7. The measurement apparatus 4 may be integrated with the observation apparatus 3.

The endoscope 2 simultaneously or alternately irradiates a subject in a living body with white light and excitation light, and simultaneously or alternately takes an image of the subject illuminated with the white light and an image of the subject illuminated with the excitation light. Thus, the endoscope 2 acquires and outputs, in time series, a pair of a white light image and a fluorescent image taken at the same time or about the same time. The subject is an organ in the living body to which a fluorescent contrast medium such as ICG has been administered for blood flow assessment. The white light image is an image obtained by imaging the reflected light of the white light from the subject, and the fluorescent image is an image obtained by imaging fluorescence from the fluorescent contrast medium excited by the excitation light.

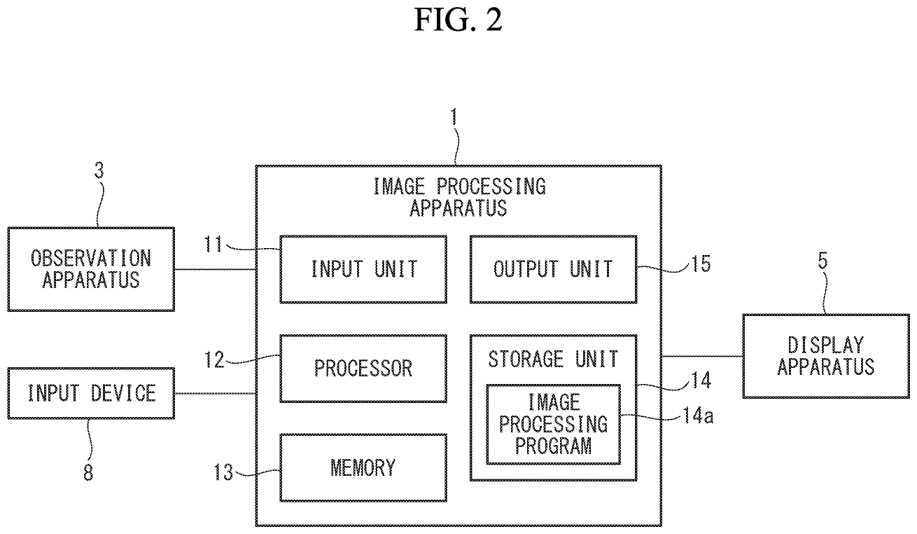

FIG. 2 is a block diagram of the image processing apparatus 1.

The image processing apparatus 1 includes an input unit 11, a processor 12 such as a central processing unit, a memory 13, a storage unit 14, and an output unit 15.

The input unit 11 has a known input interface and is connected to the observation apparatus 3. The pair of the white light image and the fluorescent image output from the endoscope 2 is input to the image processing apparatus 1 in time series through the input unit 11.

The output unit 15 has a known output interface and is connected to the display apparatus 5. The pair of the white light image and the fluorescent image is output from the output unit 15 to the display apparatus 5 in time series and displayed on the display apparatus 5.

The memory 13 is formed of a volatile storage apparatus such as random-access memory (RAM) and used as the work area of the processor 12.

The storage unit 14 is formed of a computer-readable non-temporary storage medium, such as read-only memory (ROM), flash memory, or hard disk drive. The storage unit 14 stores an image processing program 14a for causing the processor 12 to execute an image processing method. The processor 12 processes the pair of the white light image and the fluorescent image input to the image processing apparatus 1 in time series in accordance with the image processing program 14a and analyzes blood flow of a subject S.

Next, an image processing method executed by the processor 12 will be described.

The processor 12 executes the image processing method in response to a start trigger. The start trigger is input to the image processing apparatus 1, for example, by a user operating an input device 8 such as a switch provided in the measurement apparatus 4. After administering the fluorescent contrast medium to the living body, the user inputs the start trigger to the image processing apparatus 1.

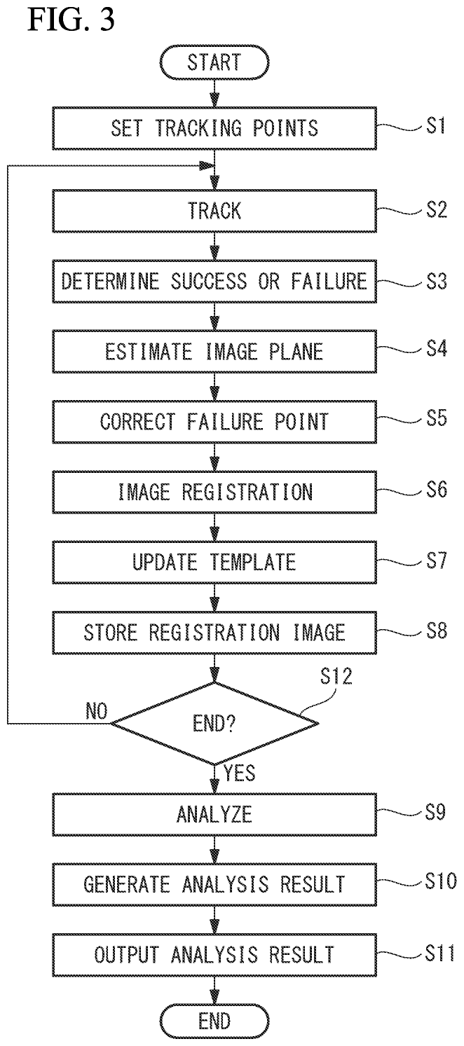

As illustrated in FIG. 3, the image processing method according to the present embodiment includes: a step S1 of setting tracking points P1, P2, . . . , Pn in a target image A; a step S2 of tracking each tracking point Pi (i=1, 2, . . . , n) from the target image A to a source image B; a step S3 of determining the success or failure in tracking each tracking point Pi; a step S4 of estimating the image plane of the source image B; a step S5 of correcting the position of the tracking point Pi having been failed to be tracked; a step S6 of generating the registration image of the source image B; a step S7 of updating a template for tracking the tracking point Pi having failed to be tracked; a step S8 of storing a registration image C; a step S9 of analyzing blood flow using the registration image C; a step S10 of creating an analysis result; and a step S11 of outputting the analysis result.

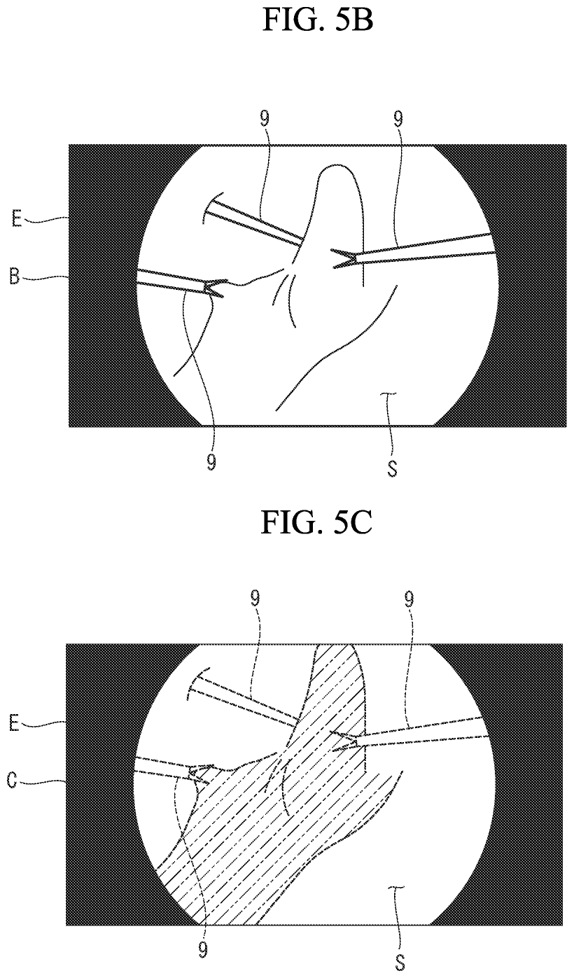

As illustrated in FIG. 5A, the target image (first image) A is one of the images of the subject S input to the image processing apparatus 1 in time series and is a white light image in the present embodiment. As illustrated in FIG. 5B, the source image (second image) B is an image at a different time from the target image A among the images of the subject S input to the image processing apparatus 1 in time series and is a white light image and a fluorescent image in the present embodiment.

The processor 12 sets a plurality of tracking points P1, P2, . . . , Pn, which are uniformly arranged in a predetermined arrangement pattern, in the target image A (step S1).

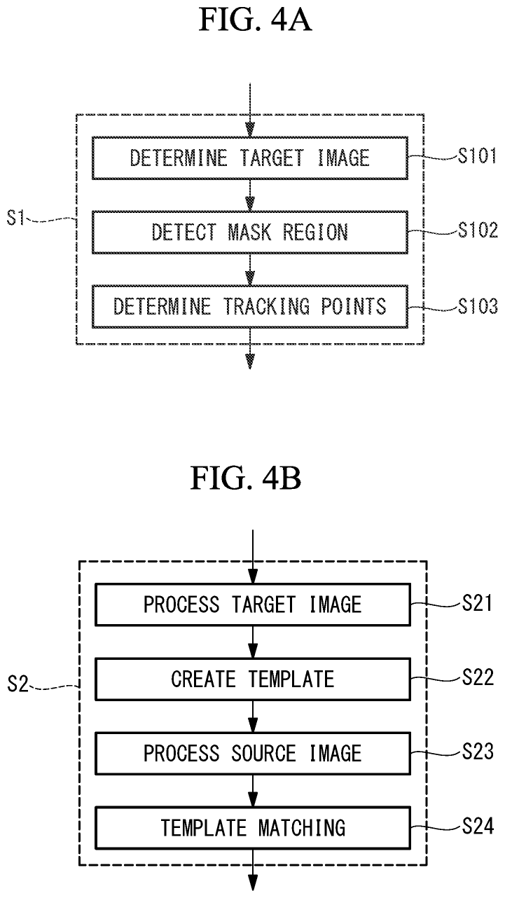

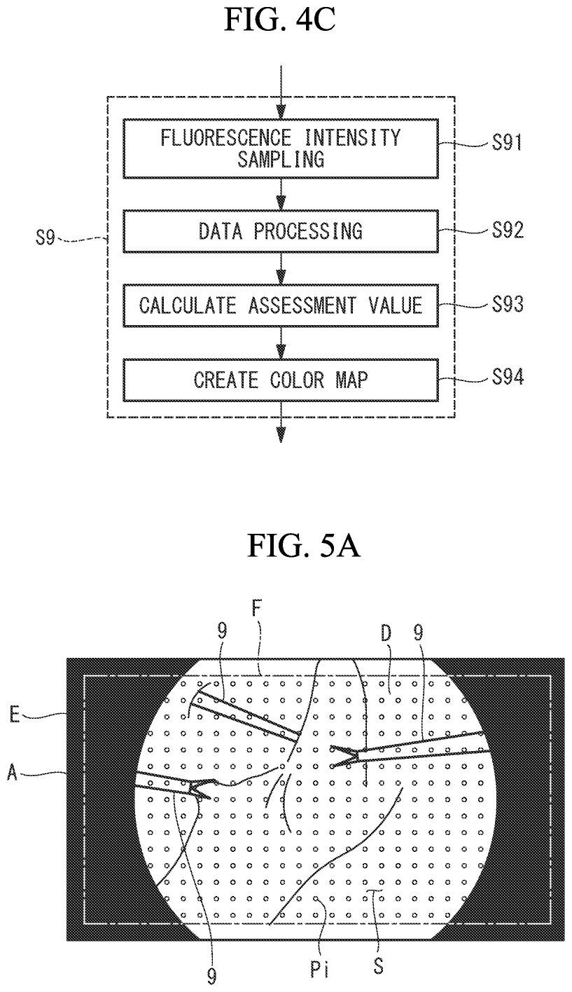

Specifically, as illustrated in FIG. 4A, the processor 12 determines, for example, a first white light image after the input of the start trigger as the target image A (step S101). Then, as illustrated in FIG. 5A, the processor 12 determines the positions of the plurality of tracking points P1, P2, . . . , Pn as intersections of grid lines arranged with equal spacing in the vertical and the horizontal directions of the target image A (step S103). Hence the plurality of tracking points P1, P2, . . . , Pn are arranged in a square array with equal spacing in the vertical and the horizontal directions.

The white light image includes a masked region E of solid black outside a field of view D of the endoscope 2 including the subject S. Preferably, the processor 12 detects the masked region E in the target image A based on, for example, color (step S102) and sets the plurality of tracking points P1, P2, . . . , Pn in the whole or substantially the whole of a region excluding the masked region E (step S103). In FIG. 5A, small white circles indicate the tracking points.

The processor 12 may uniformly set the plurality of tracking points P1, P2, . . . , Pn in a measurement region F set in the target image A. The measurement region F preferably includes the whole or a wide range of the subject S in the target image A and may be set by the user.

After step S1, the processor 12 tracks each tracking point Pi from the target image A to the source image B by template matching (step S2).

The source image B used for tracking is a white light image after time has elapsed from the target image A. When the endoscope 2 is a hand-held type, it is difficult to hold the endoscope 2 at a fixed position relative to the subject S for a long period of time, and the field of view of the endoscope 2 moves three-dimensionally relative to the subject S. Further, the subject S, which is an organ in the living body, is deformed by pulsation or the like. Thus, as illustrated in FIG. 5B, the subject S in the source image B may be misaligned relative to the subject S in the target image A.

Specifically, as illustrated in FIG. 4B, the processor 12 creates a template for each tracking point Pi from the target image A (step S22). Each template is a small region in the target image A and contains one tracking point Pi.

Next, the processor 12 determines the tracking points P1, P2, . . . , Pn in the source image B by template matching using the templates (step S24). Specifically, the processor 12 searches the source image B for a matching region most similar to each template and determines a position in the matching region corresponding to the tracking point Pi in each template as the tracking point Pi in the source image B.

The processor 12 may perform image processing such as structure enhancement and noise removal on the target image A and the source image B before steps S22 and S24 (steps S21 and S23). Tracking accuracy can be improved by using the target image A and the source image B subjected to the image processing in steps S22 and S24.

In step S24, the processor 12 may track each tracking point Pi using a method other than template matching, for example, optical flow.

The tracking of the tracking point Pi may fail due to the above-described movement of the field of view, deformation and occlusion of the subject S, and the like. The possibility of failure in the tracking increases, especially when tracking is performed for a long period of time, for example, one to two minutes.

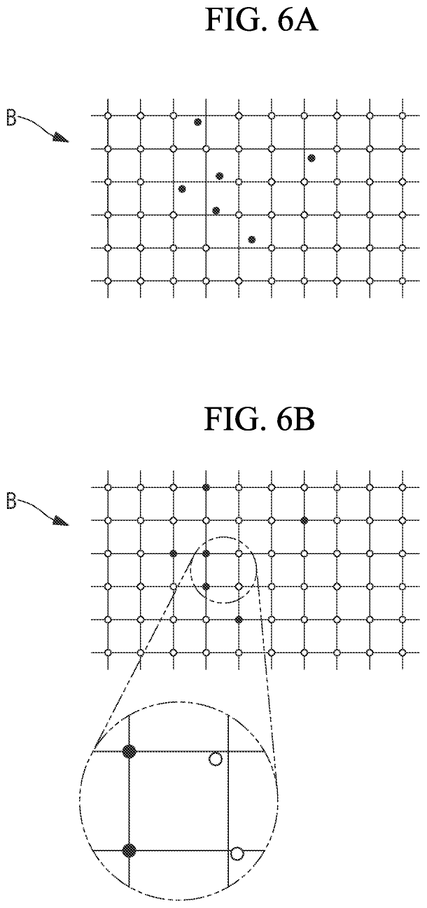

After step S2, the processor 12 determines the success or failure in tracking each tracking point Pi based on the similarity between the template and the matching region in the source image B. More specifically, as illustrated in FIG. 6A, the processor 12 determines that the tracking has succeeded when the similarity is equal to or greater than a predetermined first threshold Th1, and determines that the tracking has failed when the similarity is less than the threshold Th1. In FIGS. 6A and 6B, white circles indicate success points that are tracking points having been tracked successfully, and black circles indicate failure points that are tracking points having been failed to be tracked.

As the similarity, zero-means normalized cross-correlation (ZNCC) of the following formula may be used. ZNCC is an assessment value of image similarity calculated using normalized cross-correlation. The higher the similarity, the closer ZNCC is to 1. The threshold Th1 is, for example, 0.8.

$$ZNCC ( {d}_{x} , {d}_{y} ) = \frac{\sum \sum [ ( I ( {d}_{x} + x , {d}_{y} + y ) - {μ}_{I} ) ( T ( x , y ) - {μ}_{T} ) ]}{\sqrt{\sum \sum {[ I ( {d}_{x} + x , {d}_{y} + y ) - {μ}_{I} ]}^{2}} \sqrt{\sum \sum {[ T ( x , y ) - {μ}_{T} ]}^{2}}} \qquad \{ Formula 1 \}$$

where I(x, y) is the pixel value of the matching region, T(x, y) is the pixel value of the template, μI is the average of the pixel values of the matching region, and μT is the average of the pixel values of the template.

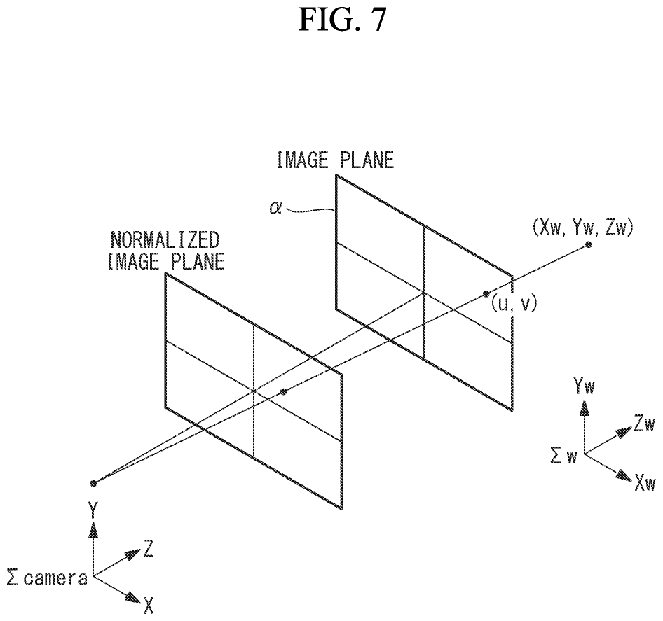

After step S3, as illustrated in FIG. 7, the processor 12 estimates an image plane α of the source image B by perspective projection transformation using only the success points (step S4). The perspective projection transformation is performed based on the following formula using the internal and external parameters of the camera of the endoscope 2.

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad \{ Formula 2 \}$$

(X, Y, Z) are three-dimensional coordinates in a world coordinate system Σw, and (u, v) are coordinates on the image plane α of the source image. cₓ, c_{y} is the principal point of the camera (usually the center of the image), and fₓ, f_{y} is the focal length expressed in pixels.

The matrix including the internal parameters cₓ, c_{y}, fₓ, f_{y} is an internal parameter matrix or a camera matrix, and when the focal length f_{y}, f_{y} is invariant, the camera matrix remains unchanged.

The matrix including the external parameters r, t is an external parameter matrix that is a translation-rotation matrix, and converts the coordinates (X, Y, Z) into a camera coordinate system Σcamera. The external parameter matrix represents the motion of the camera relative to a static environment or the rigid-body motion of the subject relative to the camera.

To estimate the image plane α of the source image B is to determine the external parameter matrix and to thereby determine the position and orientation of the camera at the time of acquisition of the source image B.

After step S4, as illustrated in FIG. 6B, the processor 12 corrects the position of the failure point on the source image B by back-projecting the failure point to the estimated image plane α (step S5). Specifically, the processor 12 back-projects the failure point in the target image A onto the image plane α using the matrix and the camera position estimated in step S4, and corrects the position of the failure point on the source image B to the back-projected position. As a result, the tracking point Pi having been failed to be tracked returns to an appropriate position on the source image B, specifically to the intersection of the grid lines.

After step S5, when the similarity is below a predetermined second threshold Th2, the processor 12 updates the template for the failure point to the small region in the target image A including the tracking point Pi at the corrected position (step S7). The second threshold Th2 is a value equal to or less than the first threshold Th1. For example, when the first threshold Th1 is 0.9, the second threshold Th2 is a value in the range of 0.8 to 0.9. Thus, when the tracking succeeds, the processor 12 uses the same template in the next tracking. On the other hand, when the tracking fails, the processor 12 uses the updated template in the next tracking. Thereby, the template is updated in accordance with the color change or the texture change of the subject S, and even after the tracking has failed, the tracking point Pi can be tracked using the updated template.

After step S5, the processor 12 performs image registration based on the plurality of tracking points P1, P2, . . . , Pn on the source image B to generate a registration image C of the source image B (step S6). The source image B on which the image registration is performed is a fluorescent image paired with the white light image used as the source image B in steps S2 to S5. The image registration is a process of aligning the subject S in the source image B with the subject S in the target image A by deforming the source image B. As illustrated in FIG. 5C, the image registration generates a registration image C in which the misalignment of the subject S in the source image B relative to the target image A due to the movement of the field of view and the deformation of the subject S has been corrected or reduced. In FIG. 5C, a hatched region indicates a fluorescent region.

The image registration is performed using thin plate spline (TPS) transformation with the tracking points P1, P2, . . . , Pn as control points. Specifically, the processor 12 sets a plurality of tracking points P1, P2, . . . , Pn in the fluorescent image. The positions of the tracking points P1, P2, . . . , Pn in the fluorescent image are the same as the positions of the tracking points P1, P2, . . . , Pn in the white light image after the positions of the failure points have been corrected. The processor 12 then generates the registration image C by nonlinearly distorting the fluorescent image so that the tracking point Pi in the fluorescent image matches the corresponding tracking point Pi in the target image A.

After step S6, the processor 12 stores the generated registration image C in the memory 13 or the storage unit 14 (step S8).

With the TPS transformation having high computational complexity, other methods, such as image registration using perspective projection, may be used.

Further, the processor 12 may perform various types of image processing such as area gain correction, shading correction, and RGB to IR conversion, on the fluorescent image as each source image B and may perform image registration on the fluorescent image subjected to the image processing.

The processor 12 repeats steps S1 to S8 each time a new pair of the white light image and the fluorescent image is input to the image processing apparatus 1, whereby a time series of registration images C is accumulated in the memory 13 or the storage unit 14.

The processor 12 ends the processing of steps S1 to S8 in response to an end trigger (YES in step S12) and proceeds to the next step S9. As the end trigger, for example, input to the image processing apparatus 1 by the user operating the input device 8 or the lapse of a predetermined measurement time from the start trigger is used.

The processor 12 analyzes blood flow using the stored time series of registration images C (step S9).

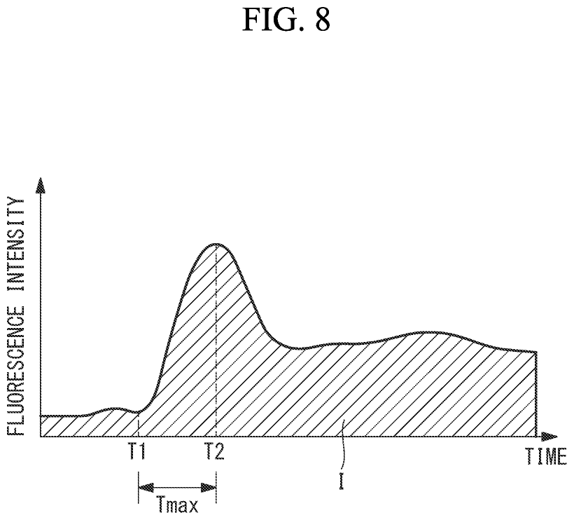

Specifically, as illustrated in FIG. 4C, the processor 12 samples the fluorescence intensity at each position in the time series of registration images C (step S91). The processor 12 may sample the average fluorescence intensity of each region (e.g., 8 pixels×8 pixels) in the registration images C. Thus, as illustrated in FIG. 8, data of a temporal change in fluorescence intensity is obtained for each position or each region of the subject S in the target image A.

Next, using the data of the fluorescence intensity, the processor 12 calculates the assessment value of the blood flow for each position of the subject S in the target image A (step S93). An example of the assessment value is a length Tmax of time from start time T1 to maximum time T2. The start time T1 is the time at which the fluorescence intensity rises, and the maximum time T2 is the time at which the fluorescence intensity reaches its maximum. Another example of the assessment value is an integrated value I of fluorescence intensity over the measurement time.

The processor 12 may perform various types of data processing such as noise removal, smoothing using a movement average or the like, and normalization of fluorescence intensity on the fluorescence intensity data (step S92) and use the processed data in step S93.

Next, the processor 12 creates a color map in which the magnitude of the assessment value of each position or each region of the subject S in the target image A is expressed using colors (step S94).

After step S9, the processor 12 creates at least one analysis result to be displayed on the display apparatus 5 (step S10). The analysis result is, for example, an overlay image in which the color map is superimposed on the target image A. The analysis result may be only the color map or may be a graph representing a temporal change in fluorescence intensity at any position in the target image A. The analysis result may be an image representing information on blood flow at each position of the subject S. The information on blood flow is, for example, the time Tmax or the time-averaged blood flow rate calculated from the integrated value I.

After step S10, the processor 12 outputs the analysis result to the display apparatus 5 to cause the analysis result to be displayed on the display apparatus 5 (step S11). The user can recognize the blood flow at each position of the subject S based on the analysis result.

As described above, according to the present embodiment, the time series of registration images C is generated from the time series of source images B acquired after the target images A. Each registration image C is an image with no or little error in the position of the subject S relative to the target image A. By using such a time series of registration images C, the fluorescence intensity at the same position of the subject S can be measured over a certain period of time, and the blood flow at each position of the subject S can be analyzed accurately.

According to the present embodiment, the plurality of tracking points P1, P2, . . . , Pn used for image registration are automatically set in the target image A by the processor 12. That is, the user does not need to set a tracking point such as a region of interest (ROI).

According to the present embodiment, after the failure in tracking the tracking point Pi, the position of the tracking point Pi on the source image B is corrected by back projection, and then the tracking point Pi, the position of which has been corrected, is tracked using the updated template. As a result, all the tracking points P1, P2, . . . , Pn can be tracked for a long period of time (e.g., one to two minutes) without any break in the tracking.

In order to accurately align the source image B with the target image A by image registration, it is necessary to accurately track the tracking points P1, P2, . . . , Pn throughout the subject S in the target image A. In a case where the position of the failure point Pi is not corrected, the tracking point Pi having once been failed to be tracked cannot be accurately tracked thereafter, resulting in a decrease in the accuracy of image registration.

In the conventional tracking method of tracking a feature point as the tracking point, a position where the tracking point can be set is limited to the positions of the characteristic structures in the treatment instrument 9 and the subject S, and the like, and the tracking point cannot be set at an arbitrary position in the image. Hence the position where blood flow can be analyzed is also limited to the position where the feature point can be set.

On the other hand, according to the present embodiment, the plurality of tracking points P1, P2, . . . , Pn are uniformly set in the target image A regardless of the presence or absence of the feature. It is thus possible to track the entire subject S in the target image A and to perform high-precision alignment of the entire subject S by image registration. This then makes it possible to analyze the blood flow of the entire subject S in the target image A.

According to the present embodiment, the tracking point to be subjected to position correction is only the tracking point having been failed to be tracked, and the tracking point on the source image B that has been tracked successfully is used for image registration without being corrected. Therefore, as illustrated in FIG. 6B, the tracking point having been tracked successfully has a minute positional deviation due to the movement of the field of view, the deformation of the subject S, and the like. By performing image registration using such a tracking point, the movement of the field of view and the deformation of the subject S can be corrected more accurately.

The endoscope 2 can not only move in the direction perpendicular to the optical axis and rotate around the optical axis but also move in the front-rear direction along the optical axis, and the field of view can be greatly enlarged or reduced by the movement in the front-rear direction. Five-axis image stabilization provided in a digital camera or the like can correct the movement and rotation of the field of view due to the movement in the direction perpendicular to the optical axis and rotation around the optical axis but cannot correct the magnification or reduction of the subject S.

According to the present embodiment, not only the movement and rotation of the image plane α of the source image B in the direction along the image plane α but also the distance from the camera position to the image plane α is estimated by perspective projection transformation.

Therefore, the positional deviation of the tracking point Pi on the source image B due to the enlargement or reduction of the subject S can also be corrected.

Further, the tracking of the tracking point in the masked region E is unnecessary, and the size and shape of the masked region E vary depending on the endoscope 2. According to the present embodiment, the masked region E in the target image A is automatically detected, and the tracking points P1, P2, . . . , Pn are set in the region excluding the masked region E, thereby making it possible to reduce the computational complexity and time required for tracking.

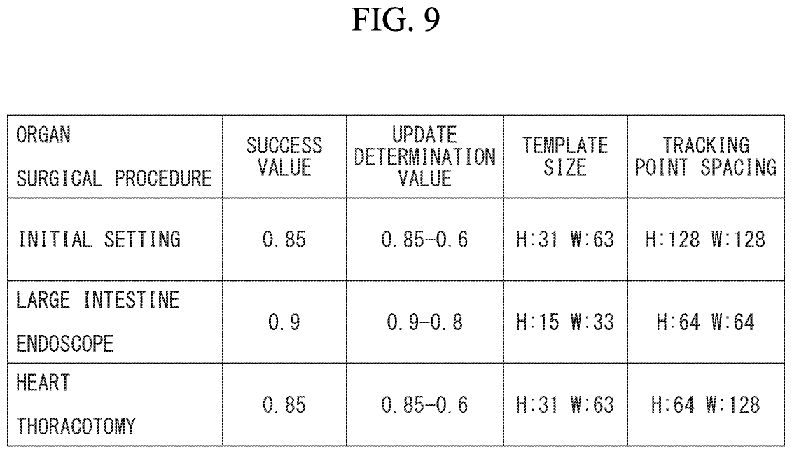

In the above embodiment, the processor 12 may acquire information about the subject S or the surgical procedure and change the conditions for tracking the tracking point based on the information. The tracking conditions include at least one of the threshold Th1 (success value) for determining the success or failure in tracking, the threshold Th2 (update determination value) for updating the template, and the arrangement of the tracking points. The arrangement of the tracking points includes at least one of the spacing or number of tracking points in each of the horizontal and vertical directions of the target image A and the size of the template. FIG. 9 illustrates an example of the relationship between the subject S/surgical procedure and the conditions.

In this case, the image processing apparatus 1 may include an acquisition unit that acquires the information. The acquisition unit is, for example, the input device 8, and the user can input at least one of the type of the subject S and the surgical procedure to the image processing apparatus 1 by using the input device 8.

In the embodiment described above, the image processing apparatus 1 processes the time series of white light images and the fluorescent images input to the image processing apparatus 1 in real time, but alternatively, the image processing apparatus 1 may process a time series of white light images and fluorescent images acquired in the past. For example, the image processing apparatus 1 may process a moving image of the subject S recorded in the memory 13 or the storage unit 14.

In the above embodiment, the source image is an image acquired after the target image, but alternatively, the source image may be an image acquired before the target image.

For example, in a case where the time series of registration images C is generated using recorded moving images, one white light image at any given time may be determined as the target image, and a white light image and a fluorescent image at another time may be used as the source image.

In the above embodiment, the image processing apparatus 1 analyzes blood flow using the registration image C of the fluorescent image, but steps S9 to S10 may not be performed. In this case, the image processing apparatus 1 may cause the time series of registration images C to be displayed on the display apparatus 5, instead of the analysis result. The user can recognize the accurate temporal change in fluorescence intensity at each position of the subject S by viewing the time series of registration images C, and can accurately evaluate the blood flow at each position.

In the above embodiment, the processor 12 generates the registration image C of the fluorescent image, but alternatively or additionally, the processor 12 may generate the registration image of the white light image. In this case, the processor 12 may analyze the subject S using the registration image of the white light image instead of or in addition to steps S9 to S11.

In the above embodiment, the processor 12 sets the plurality of tracking points P1, P2, . . . , Pn in a square array in the target image A, but the arrangement of the plurality of tracking points P1, P2, . . . , Pn in the target image A is not limited thereto, and other arrangements may be used. For example, the plurality of tracking points P1, P2, . . . , Pn may be geometrically arranged at the respective vertexes of any polygon. The plurality of tracking points P1, P2, . . . , Pn are preferably regularly arranged with equal spacing but may be irregularly arranged with unequal spacing.

While the embodiment and modifications of the present invention have been described above, the scope of the present invention is not limited thereto, and various improvements can be made without departing from the gist of the present invention. For example, the target image and the source image may be other types of images than the white light image and the fluorescent image. The target image and the source image may be images other than the endoscope image, and the image processing apparatus 1 may be applied to systems other than the endoscope system 100.

### REFERENCE SIGNS LIST

1 image processing apparatus
5 display apparatus
12 processor
14 storage unit (storage medium)
Pi tracking point
S subject
A target image (first image)
B source image (second image)
C registration image
E masked region
α image plane

1. An image processing apparatus for processing a time series of images of a subject, the image processing apparatus comprising:
a processor,
wherein the processor is configured to:
set a plurality of tracking points uniformly arranged in a first image that is one of the time series of images,
track each of the tracking points from the first image to a second image and determine success or failure in tracking each of the tracking points, the second image being an image at a different time from the first image among the time series of images,
estimate an image plane of the second image aby perspective projection transformation using the tracking points tracked successfully,
correct positions of the tracking points failed to be tracked on the second image by back projection to the image plane, and
perform image registration for aligning the second image with the first image on the second image based on the plurality of tracking points to generate a registration image.

2. The image processing apparatus according to claim 1, wherein
the processor is further configured to:
acquire information about the subject or a surgical procedure, and
set a condition for tracking each of the tracking points in accordance with the information, the condition including at least one of a threshold for determining the success or failure in the tracking, a threshold for updating a template used for the tracking, and an arrangement of the plurality of tracking points.

3. The image processing apparatus according to claim 1, wherein
the time series of images include a time series of white light images of the subject, and
the processor is configured to, using the white light images as the first image and the second image, track the plurality of tracking points, estimate the image plane, and correct the position of the tracking point failed to be tracked.

4. The image processing apparatus according to claim 3, wherein
the time series of images further include a time series of fluorescent images of the subject,
the processor is configured to perform the image registration using the fluorescent image as the second image, and
the processor is further configured to analyze blood flow of the subject based on fluorescence intensities of a time series of the registration images.

5. The image processing apparatus according to claim 4, wherein
the processor is further configured to:
generate an overlay image in which an analysis result of the blood flow is superimposed on the first image, and
cause the overlay image to be displayed on a display apparatus.

6. The image processing apparatus according to claim 3, wherein the processor is configured to detect a masked region in the first image, and set the plurality of tracking points in a region excluding the masked region.

7. An image processing method for processing a time series of images of a subject, the image processing method comprising:
setting a plurality of tracking points uniformly arranged in a first image that is one of the time series of images;
tracking each of the tracking points from the first image to a second image and determining success or failure in tracking each of the tracking points, the second image being an image at a different time from the first image among the time series of images;
estimating an image plane of the second image by perspective projection transformation using the tracking points tracked successfully;
correcting positions of the tracking points failed to be tracked on the second image by back projection to the image plane; and
performing image registration for aligning the second image with the first image on the second image based on the plurality of tracking points to generate a registration image.

8. A non-transitory computer-readable storage medium storing an image processing program for processing a time series of images of a subject, wherein the image processing program causes a computer to execute:
setting a plurality of tracking points uniformly arranged in a first image that is one of the time series of images;
tracking each of the tracking points from the first image to a second image and determining success or failure in tracking each of the tracking points, the second image being an image at a different time from the first image among the time series of images;
estimating an image plane of the second image by perspective projection transformation using the tracking points tracked successfully;
correcting positions of the tracking points failed to be tracked on the second image by back projection to the image plane; and
performing image registration for aligning the second image with the first image on the second image based on the plurality of tracking points to generate a registration image.
